(19) United States
(12) Patent Application Publication
(10) Pub. No.: US 2010/0014767 A1
(43) Pub. Date: Jan. 21, 2010

(54) AUTO-FIT ENHANCEMENTS TO SUPPORT DOCUMENTS WITH ENGINEERING FOLDS

(75) Inventor: Javier A. Morales, Rochester, NY (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/174,285

(22) Filed: Jul. 16, 2008

(51) Int. Cl. G06K 9/40

(52) U.S. Cl. 382/254

(57) ABSTRACT

A document is produced in response to a request. The request specifies a series of document components that form the document when properly combined. At least one of the document components does not have an acceptable size. An acceptable size is a size matching available print media and compatibility with the sizes of the other document components. A scaling module adjusts any unacceptably sized document components to having acceptable sizes. The document is then produced by a rendering device.

### TECHNICAL FIELD

Embodiments are related to printing and more specifically to the processing of documents requests, assembling document description for document components, and automatically scaling document components.

### BACKGROUND

A user desiring a document can employ a content management system to produce a request for the document. The request often specifies a series of document components that can be concatenated to form the desired document. The document components are often specified by component descriptions that are computer files containing page description language (PDL) data. A prepress module can process the request by obtaining the appropriate component descriptions from a server and combining them into a document description. The document description can then be passed to a printer that then produces the document.

Many document components have a size specification. For example, a letter size specification instructs the printer to produce the pages of the document component on rectangular media measuring 8.5 inches by 11 inches. Similarly, tabloid size measures 11 inches by 17 inches. There are many other standard size specifications. In North America, legal size and ledger size are common as well as letter and tabloid. The international standards organization (ISO) has standards ISO 216, ISO 269, and ISO 217 specifying standard media sizes including A0 through A10, B0 through B10, C0 through C10 and DL. The ISO paper size standards and the North American paper size standards are notoriously well known amongst those skilled in the art of printing.

A request can specify a document containing document components of different sizes. The sizes are often incompatible. For example, a document can have many letter size document components and a few tabloid size document components. The tabloid size sheets can be folded in half to compatibly fit inside a letter size document. Other media sizes, however, could be incompatible and thereby require special attention from the user or the printing press operator.

Methods and systems for automatically resolving differences in document component media sizes such that a document contains only compatible media are needed.

### BRIEF SUMMARY

Aspects of the embodiments address limitations and flaws in the prior art by using a code value to flag pixels that are not properly mapped and replacing the flagged pixels with analytic values.

It is therefore an aspect of the embodiments that a content management module creates a request for a document. The document is made of document components such that properly combining the document components results in the production of the document.

It is another aspect of the embodiments that an automated prepress module receives the request and assembles a document description. The document description is made of a number of component descriptions and with each component description describes a document component.

It is yet another aspect of the embodiments to have at least one acceptable size. Each acceptable size can be specified by an acceptable size specification or can result from the application of scaling rules.

It is a further aspect of the embodiments that one or more of the component description has a size specification that does not equal any of the acceptable sizes.

It is yet a further aspect of the embodiments that a scaling module adjusts component descriptions so that every component description has an accepted size equaling one of the acceptable sizes.

It is still yet a further aspect of the embodiments that a rendering device renders the document description to thereby produce the document.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention

FIG. 1 illustrates a system processing a request and producing a document in accordance with aspects of the embodiments;

FIG. 2 illustrates a prepress module adjusting the sizes of component descriptions based on scaling rules in accordance with aspects of certain embodiments; and

FIG. 3 illustrates examples of scaling rules in accordance with aspects of certain embodiments.

### DETAILED DESCRIPTION OF THE INVENTION

The particular values and configurations discussed in these non-limiting examples can be varied and are cited merely to illustrate embodiments and are not intended to limit the scope of the invention.

A document is produced in response to a request. The request specifies a series of document components that form the document when properly combined. At least one of the document components does not have an acceptable size. An acceptable size is a size matching available print media and compatible with the sizes of the other document components. A scaling module adjusts any unacceptably sized document components to having acceptable sizes. The document is then produced by a rendering device.

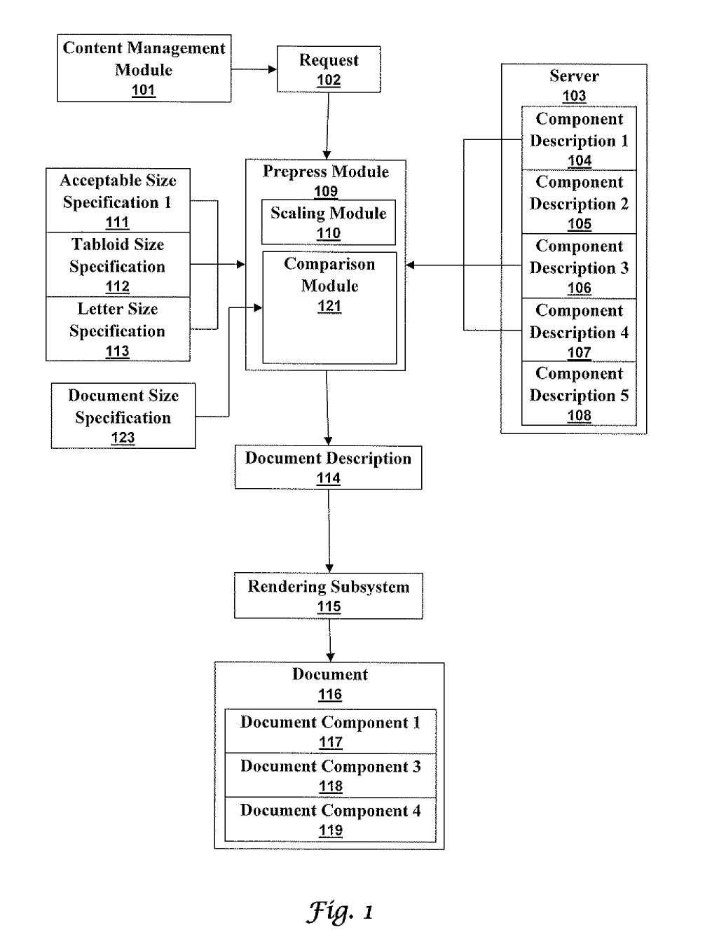

FIG. 1 illustrates a system processing a request 102 and producing a document 116 in accordance with aspects of the embodiments. A user employs a content management module 101 to produce a request 102 that can be passed to a prepress module 109. The request 102 specifies the document components that can be combined to form the document 116. A server 103 can store component descriptions such as component description 1 104, component description 2 105, component description 3 106, component description 4 107, and component description 5 108. The prepress module 109 can obtain component descriptions such as component description 1 104, component description 3 106, and component description 4 107 from the server and combine them into a document description 114. The prepress module 109 contains a scaling module 110 that ensures that the component descriptions are of an acceptable size.

The system can include acceptable size specifications such as acceptable size specification 1 1111 tabloid size specification 112, and letter size specification 113. If a document component does not have an acceptable size, then the scaling module 110 adjusts it such that every document component in the document description 114 does have an acceptable size.

The scaling module 109 can be programmed to scale different component descriptions in different ways. For example, raster component descriptions can be scaled down (enlarged) but never down. Vector component descriptions can usually be scaled either up or down without loss of quality.

A document size specification 123 can indicate the documents size such that a comparison module 121 can cause the scaling module 121 to scale every component description to the document size. Alternatively, the document size specification 123 can specify the document size and the sizes of compatibly sized media. For example, tabloid size media can be folded to properly fit into a letter size document. As such, the document components can be scaled to either tabloid size or letter size based on the rules or programming of the scaling module 110 and comparison module 121.

In certain embodiments, a user, such as the user producing the request 102, can set the document size specification 123. As such, a document normally printed as letter size can be easily printed as a pamphlet (8.5″×5.5″) by simply setting the document size specification. The prepress module 109 and the scaling module 110 ensure that the document description 114 contains only component descriptions having an accepted size where every accepted size in the instant example is compatible with pamphlet size.

The document description 114 can be passed to a rendering device, such as a printer, that then produces the document 116. In the figure, document component 1 117, document component 2 118, and document component 4 119 are concatenated and bound to form document 116.

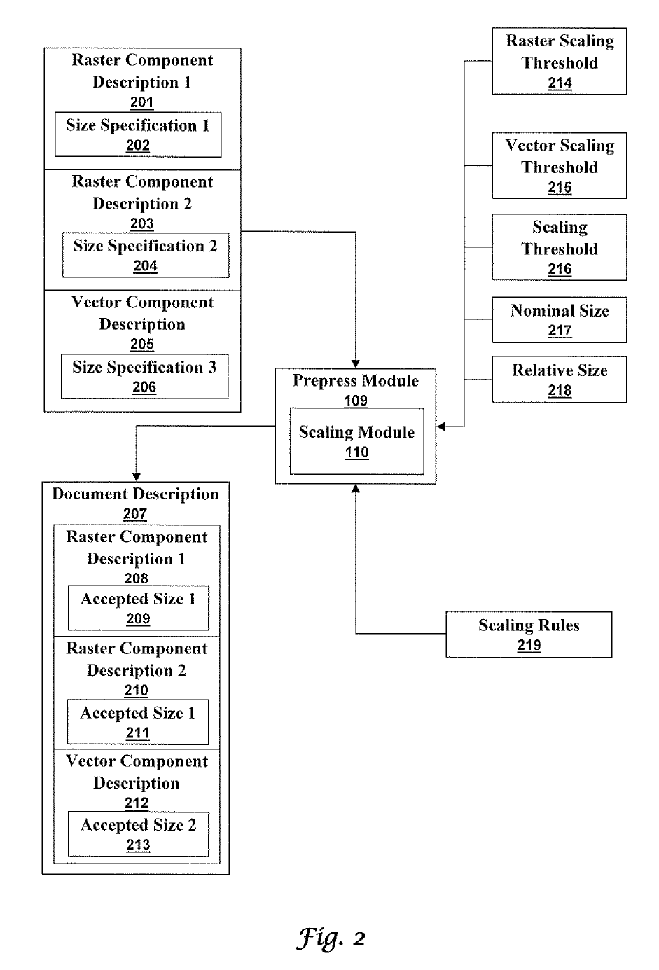

FIG. 2 illustrates a prepress module 109 adjusting the sizes of component descriptions based on scaling rules 219 in accordance with aspects of certain embodiments. As obtained from a server, raster component description 1 201 is sized size specification 1 202, raster component description 2 203 is sized size specification 2 204, and vector component description 205 is sized size specification 3 206. The scaling module 110 adjust the component descriptions such that after scaling raster component description 1 208 is sized accepted size 1 209, raster component description 2 210 is sized accepted size 1 211, and vector component description 212 is sized accepted size 2 213.

Scaling rules 219 can control how the scaling module 110 scales component description. The scaling rules 219 can use system values, possibly set by the user, such as raster scaling threshold 214, vector scaling threshold 215, scaling threshold 216, nominal size 217, and relative size 218.

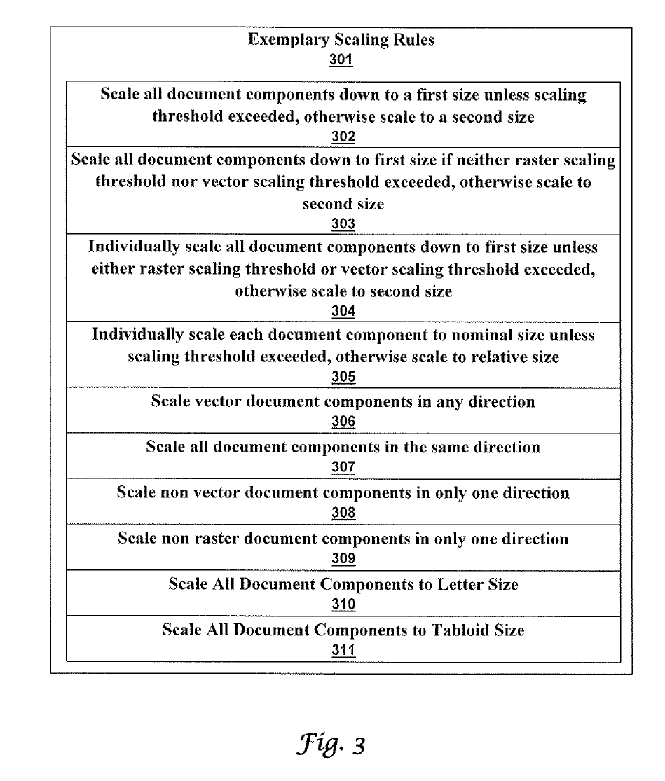

FIG. 3 illustrates exemplary scaling rules 301 in accordance with aspects of certain embodiments. Note that these are examples only in that some of the illustrated rules are mutually exclusive. The first rule is to scale all document components down to a first size unless the scaling threshold is exceeded and to otherwise scale to a second size 302. For example, the first size can be letter size and the second size can be tabloid size. The scaling threshold is used to ensure that nothing is shrunk too much such that legibility is compromised.

The second rule is to scale all document components down to a first size if neither a raster scaling threshold nor a vector scaling threshold is exceeded and to otherwise scale to a second size 303. Those skilled in the art of computer graphics are familiar with vector graphics or images and with raster graphics or image. The second rule is similar to the first with the exception that raster graphics and vector graphics have different scaling thresholds. The reason is that vector graphics can usually be legibly scaled over a wider range than raster graphics.

The third rule is to individually scale all document components down to a first size unless either raster scaling threshold or vector scaling threshold exceeded, otherwise scale to second size 304. The third rule is different from the second in that the document components are individually scaled. As such, some can be scaled to the first size and others to the second size. Under rules one and two, all document components are scaled to the same size.

The fourth rule is to individually scale each document component to a nominal size unless scaling threshold is exceeded, otherwise scale to relative size 305. The fifth rule is to scale vector document components in any direction 306. The sixth rule is to scale all document components in the same direction 307. The seventh rule is to scale non vector document components in only one direction 308. The eighth rule is to scale non raster document components in only one direction 309. The ninth rule is to scale all document components to letter size 310. The tenth rule is to scale all document components to tabloid size 311.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims:

1. A system comprising:
a content management module that creates a request for a document wherein the document comprises a plurality of document components;
at least one acceptable size specification;
an automated prepress module comprising a scaling module wherein the automated prepress module receives the request and assembles a document description from a plurality of component descriptions, wherein at least one of the component descriptions comprises a size specification not equaling any of the at least one acceptable size specification, and wherein the scaling module adjusts at least one of the component descriptions such that every one of the document component descriptions comprises an accepted size equaling one of the acceptable size specifications; and
a rendering subsystem that interprets the document description and thereby produces the document.

2. The system of claim 1 wherein one of the at least one acceptable size specification is tabloid size.

3. The system of claim 1 wherein one of the at least one acceptable size specification is letter size.

4. The system of claim 1 further comprising a document size specification, a tabloid size specification, and a letter size specification and a comparison module that sets an accepted size to either the tabloid size specification or the letter size specification based on the document size specification.

5. The system of claim 1 wherein the scaling module scales the document components in only one direction wherein scaling up is magnification and scaling down is shrinking.

6. The system of claim 1 wherein the scaling module scales raster document components in only one direction wherein scaling up is magnification and scaling down is shrinking and wherein the scaling module scales non raster document components in any direction.

7. The system of claim 1 wherein the scaling module scales vector document components in any direction and scales all other document components in only one direction wherein scaling up is magnification and scaling down is shrinking.

8. A system comprising:
a content management module that creates a request for a document wherein the document comprises a plurality of document components;
at least one scaling rule;
an automated prepress module comprising a scaling module wherein the automated prepress module receives the request and assembles a document description from a plurality of component descriptions, wherein at least one of the component descriptions comprises a size specification and wherein the at least one scaling rule guides the scaling module to adjust the size of at least one of the component descriptions; and
a rendering subsystem that interprets the document description and thereby produces the document.

9. The system of claim 8 wherein the at least one scaling rule is to scale all document components that are not tabloid size to tabloid size.

10. The system of claim 8 wherein one of the at least one scaling rule is to scale all document components that are not letter size to letter size.

11. The system of claim 8 further comprising a scaling threshold wherein the at least one scaling rule comprises a rule to scale all document components down to a first size if the scaling threshold is not exceeded and to otherwise scale all document components up to a second size.

12. The system of claim 8 further comprising a raster scaling threshold and a vector scaling threshold wherein the at least one scaling rule comprises a rule to scale all document components down to a first size if neither the raster scaling threshold nor the vector scaling threshold is exceeded and to otherwise scale all document components up to a second size.

13. The system of claim 8 wherein one of the at least one scaling rule is to scale all document components in the same direction.

14. The system of claim 8 wherein one of the at least one scaling rule is that raster document components are never scaled down.

15. The system of claim 8 comprising a nominal size, a scaling threshold and a relative size wherein the at least one scaling rule comprises a rule to scale each document component individually to the nominal size unless the scaling threshold is exceeded and otherwise to the relative size.

16. The system of claim 15 further comprising a means for a user to choose the relative size.

17. A system comprising:
a content management module that creates a request for a document wherein the document comprises a plurality of document components;
an automated prepress module comprising a means for scaling document components wherein the automated prepress module receives the request and assembles a document description from a plurality of component descriptions; and
a rendering subsystem that interprets the document description and thereby produces the document wherein the means for scaling document components scales at least one of the document components such that all of the document components are sized to fit the document.

18. The system of claim 17 further comprising a scaling threshold wherein all the document components are scaled down to a first size if the scaling threshold is not exceeded and to otherwise are scaled up to a second size.

19. The system of claim 17 further comprising a raster scaling threshold and a vector scaling threshold wherein all the document components are scaled down to a first size if neither the raster scaling threshold nor the vector scaling threshold is exceeded and are otherwise scaled up to a second size.

20. The system of claim 17 comprising a nominal size, a scaling threshold and a relative size wherein each document component is individually scaled to the nominal size if the scaling threshold is not exceeded and otherwise to the relative size.
